(19) United States
(12) Patent Application Publication
(10) Pub. No.: US 2023/0354318 A1
(43) Pub. Date: Nov. 2, 2023

(54) UPLINK CONTROL INFORMATION MAPPING FOR UPLINK TRANSMISSION SWITCHING

(71) Applicant: QUALCOMM Incorporated, San Diego, CA (US)

(72) Inventors: Yiqing CAO, Beijing (CN); Peter GAAL, San Diego, CA (US); Wanshi CHEN, San Diego, CA (US); Alberto RICO ALVARINO, San Diego, CA (US)

(21) Appl. No.: 18/245,710

(22) PCT Filed: Dec. 4, 2020
(86) PCT No.: PCT/CN2020/133782

§ 371 Date: Mar. 16, 2023

(51) Int. Cl. H04W 72/1268; H04W 72/21

(52) U.S. Cl. CPC H04W 72/1268; H04W 72/21

(57) ABSTRACT

Methods, systems, and devices for wireless communications are described. A user equipment (UE) may be configured to perform dual uplink transmissions on two different operating bands of a carrier aggregation configuration. The UE may communicate on a primary cell associated with a primary component carrier and a secondary cell associated with a secondary component carrier. The UE may generate uplink control information (UCI) for the secondary cell, which is mapped to an uplink shared transmission of the primary cell. In some cases, however, the UE may identify that uplink transmission switching is to occur prior to the transmission of the UCI, such that UE may not map the UCI to the uplink shared transmission of the primary cell. Accordingly, the UE may modify a cell mapping for the transmission of the UCI based on the identified uplink transmission switching.

### CROSS REFERENCE

The present Application is a 371 national stage filing of International PCT Application No. PCT/CN2020/133782 by CAO et al. entitled “UPLINK CONTROL INFORMATION MAPPING FOR UPLINK TRANSMISSION SWITCHING,” filed Dec. 4, 2020, which is assigned to the assignee hereof, and which is expressly incorporated by reference in its entirety herein.

### TECHNICAL FIELD

The following relates to wireless communications, and more specifically to uplink control information mapping for uplink transmission switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications networks may utilize uplink transmission switching to increase resource availability and uplink performance. Conventional techniques for supporting uplink transmission switching in the network, however, may be deficient.

### SUMMARY

The described techniques relate to improved methods, systems, devices, and apparatuses that support uplink control information mapping for uplink transmission switching. Generally, the described techniques provide for modifying the component carrier mapping of uplink control information (UCI) upon identification of uplink transmission switching at a user equipment (UE). In some wireless communications systems, the UE may be configured to perform dual uplink transmissions on two different operating frequency bands of an inter-band carrier aggregation configuration. The UE may communicate on a primary cell associated with a primary component carrier and a secondary cell associated with a secondary component carrier using a number of specified uplink and downlink slots of the carrier.

In addition, the UE may support uplink transmission switching between uplink slots for each carrier to increase throughput and uplink performance. In some examples, the UE may multiplex or map UCI from the secondary component carrier with a physical uplink shared channel (PUSCH) transmission on the primary component carrier. In some cases, however, the UE may identify that uplink transmission switching is to occur from the primary component carrier to the secondary component carrier prior to the transmission of the UCI. In such cases, the UE may modify the mapping of the UCI. In some examples, the UE may drop the UCI on the secondary component carrier. In some other examples, the UE may multiplex the UCI with a set of subsequent consecutive uplink slots on the primary component carrier. In yet other examples, the UE may transmit the UCI on a PUSCH using a next available uplink slot of the secondary component carrier.

A method for wireless communications at a user equipment (UE) is described. The method may include operating in accordance with an uplink carrier aggregation configuration on a primary cell and a secondary cell, receiving a grant for an uplink shared channel transmission mapped to the primary cell on a first set of uplink slots, generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information, and modifying a cell mapping for the transmission of the uplink control information based on the uplink transmission switching.

An apparatus for wireless communications at a UE is described. The apparatus may include a processor, memory in electronic communication with the processor, and instructions stored in the memory. The instructions may be executable by the processor to cause the apparatus to operate in accordance with an uplink carrier aggregation configuration on a primary cell and a secondary cell, receive a grant for an uplink shared channel transmission mapped to the primary cell on a first set of uplink slots, generate uplink control information mapped to the secondary cell, where the uplink shared channel transmission is scheduled to overlap with the uplink control information and uplink transmission switching is scheduled to occur from the primary cell to the secondary cell prior to a transmission of the uplink control information, and modify a cell mapping for the transmission of the uplink control information based on the uplink transmission switching.

Another apparatus for wireless communications at a UE is described. The apparatus may include means for operating in accordance with an uplink carrier aggregation configuration on a primary cell and a secondary cell, means for receiving a grant for an uplink shared channel transmission mapped to the primary cell on a first set of uplink slots, means for generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information, and means for modifying a cell mapping for the transmission of the uplink control information based on the uplink transmission switching.

A non-transitory computer-readable medium storing code for wireless communications at a UE is described. The code may include instructions executable by a processor to operate in accordance with an uplink carrier aggregation configuration on a primary cell and a secondary cell, receive a grant for an uplink shared channel transmission mapped to the primary cell on a first set of uplink slots, generate uplink control information mapped to the secondary cell, where the uplink shared channel transmission is scheduled to overlap with the uplink control information and uplink transmission switching is scheduled to occur from the primary cell to the secondary cell prior to a transmission of the uplink control information, and modify a cell mapping for the transmission of the uplink control information based on the uplink transmission switching.

In some examples of the method, apparatuses, and non-transitory computer-readable medium described herein, modifying the cell mapping for the transmission of the uplink control information may include operations, features, means, or instructions for dropping the transmission of the uplink control information on the secondary cell based on the uplink transmission switching.

In some examples of the method, apparatuses, and non-transitory computer-readable medium described herein, the transmission of the uplink control information on the secondary cell may be dropped for consecutive uplink slots of the primary cell.

In some examples of the method, apparatuses, and non-transitory computer-readable medium described herein, modifying the cell mapping for the transmission of the uplink control information may include operations, features, means, or instructions for mapping the transmission of the uplink control information on the secondary cell to a second set of uplink slots of the primary cell different from the first set of uplink slots based on the uplink transmission switching.

In some examples of the method, apparatuses, and non-transitory computer-readable medium described herein, the second set of uplink slots include a subsequent set of consecutive slots that may be available for transmission of the uplink control information.

In some examples of the method, apparatuses, and non-transitory computer-readable medium described herein, modifying the cell mapping for the transmission of the uplink control information may include operations, features, means, or instructions for mapping the transmission of the uplink control information of the secondary cell from a first uplink slot of the secondary cell to a second uplink slot of the secondary cell based on the uplink transmission switching.

In some examples of the method, apparatuses, and non-transitory computer-readable medium described herein, the second uplink slot of the secondary cell may be a subsequent slot that may be available for transmission of the uplink control information.

In some examples of the method, apparatuses, and non-transitory computer-readable medium described herein, the uplink transmission switching may include operations, features, means, or instructions for dropping the uplink shared channel transmission on the first set of uplink slots of the primary cell.

In some examples of the method, apparatuses, and non-transitory computer-readable medium described herein, the uplink carrier aggregation configuration may be an inter-band carrier aggregation configuration supporting dual uplink transmission.

In some examples of the method, apparatuses, and non-transitory computer-readable medium described herein, the dual uplink transmission includes at least one uplink transmission on one or more component carriers associated with the primary cell and the secondary cell.

In some examples of the method, apparatuses, and non-transitory computer-readable medium described herein, the uplink control information of the secondary cell may be multiplexed with the uplink shared channel transmission of the primary cell.

In some examples of the method, apparatuses, and non-transitory computer-readable medium described herein, the primary cell may be associated with a first carrier frequency and the secondary cell may be associated with a second carrier frequency that may be different from the first carrier frequency.

In some examples of the method, apparatuses, and non-transitory computer-readable medium described herein, the primary cell and the secondary cell may be associated with a common cell group.

A method for wireless communications at a base station is described. The method may include transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information and receiving, from the UE, the uplink control information in accordance with a modified cell mapping of the UE based on the uplink transmission switching.

An apparatus for wireless communications at a base station is described. The apparatus may include a processor, memory in electronic communication with the processor, and instructions stored in the memory. The instructions may be executable by the processor to cause the apparatus to transmit, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information and receive, from the UE, the uplink control information in accordance with a modified cell mapping of the UE based on the uplink transmission switching.

Another apparatus for wireless communications at a base station is described. The apparatus may include means for transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information and means for receiving, from the UE, the uplink control information in accordance with a modified cell mapping of the UE based on the uplink transmission switching.

A non-transitory computer-readable medium storing code for wireless communications at a base station is described. The code may include instructions executable by a processor to transmit, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information and receive, from the UE, the uplink control information in accordance with a modified cell mapping of the UE based on the uplink transmission switching.

Some examples of the method, apparatuses, and non-transitory computer-readable medium described herein may further include operations, features, means, or instructions for receiving the transmission of the uplink control information on a second set of uplink slots of the primary cell different from the first set of uplink slots in accordance with the modified cell mapping of the UE.

In some examples of the method, apparatuses, and non-transitory computer-readable medium described herein, the second set of uplink slots include a subsequent set of consecutive slots that may be available for transmission of the uplink control information.

In some examples of the method, apparatuses, and non-transitory computer-readable medium described herein, the uplink transmission switching may include operations, features, means, or instructions for dropping the grant for the uplink shared channel transmission on the first set of uplink slots of the primary cell.

In some examples of the method, apparatuses, and non-transitory computer-readable medium described herein, the base station supports inter-band carrier aggregation for receiving uplink transmissions from the UE.

In some examples of the method, apparatuses, and non-transitory computer-readable medium described herein, the uplink control information may be multiplexed with the uplink shared channel transmission of the primary cell.

In some examples of the method, apparatuses, and non-transitory computer-readable medium described herein, the primary cell may be associated with a first carrier frequency and the secondary cell may be associated with a second carrier frequency that may be different from the first carrier frequency.

In some examples of the method, apparatuses, and non-transitory computer-readable medium described herein, the primary cell and the secondary cell may be associated with a common cell group.

### BRIEF DESCRIPTION OF THE DRAWINGS

FIG. 1 illustrates an example of a wireless communications system that supports uplink control information mapping for uplink transmission switching in accordance with aspects of the present disclosure.

FIG. 2 illustrates an example of a wireless communications system that supports uplink control information mapping for uplink transmission switching in accordance with aspects of the present disclosure.

FIG. 3 illustrates examples of uplink control information (UCI) mapping configurations that support uplink control information mapping for uplink transmission switching in accordance with aspects of the present disclosure.

FIG. 4 illustrates an example of a process flow that supports uplink control information mapping for uplink transmission switching in accordance with aspects of the present disclosure.

FIGS. 5 and 6 show block diagrams of devices that support uplink control information mapping for uplink transmission switching in accordance with aspects of the present disclosure.

FIG. 7 shows a block diagram of a communications manager that supports uplink control information mapping for uplink transmission switching in accordance with aspects of the present disclosure.

FIG. 8 shows a diagram of a system including a device that supports uplink control information mapping for uplink transmission switching in accordance with aspects of the present disclosure.

FIGS. 9 and 10 show block diagrams of devices that support uplink control information mapping for uplink transmission switching in accordance with aspects of the present disclosure.

FIG. 11 shows a block diagram of a communications manager that supports uplink control information mapping for uplink transmission switching in accordance with aspects of the present disclosure.

FIG. 12 shows a diagram of a system including a device that supports uplink control information mapping for uplink transmission switching in accordance with aspects of the present disclosure.

FIGS. 13 through 18 show flowcharts illustrating methods that support uplink control information mapping for uplink transmission switching in accordance with aspects of the present disclosure.

### DETAILED DESCRIPTION

To increase network coverage and system bandwidth, some wireless communications systems may support inter-band carrier aggregation, which enables the aggregation of carriers of two different operating frequency bands. To operate in accordance with the inter-band carrier aggregation configuration, a user equipment (UE) may be configured to perform uplink transmissions on two separate transmission chains associated with the two different operating frequency bands. The UE may further operate on a number of different serving cells according to the carrier aggregation configuration. For example, the UE may communicate on a primary cell associated with a primary component carrier and a secondary cell associated with a secondary component carrier. The UE may communicate on each serving cell in accordance with a scheduling configuration, for example, the UE may receive downlink data during a number of specified downlink slots of the carrier and may transmit uplink data in a number of specified uplink slots of each carrier.

To further enhance uplink throughput, the UE may support uplink transmission switching between uplink slots for each carrier. For example, the UE may switch between the two different operating bands to enable uplink multiple-input multiple-output (MIMO) on the primary cell and to increase uplink resource utilization. In an uplink transmission switching procedure, a first uplink transmission may be fixed on the primary component carrier, and second uplink transmission may be switched between the primary component carrier and the secondary component carrier. By adaptively switching between component carriers, the UE may increase the number of uplink transmission opportunities available for use.

In some examples, the UE may multiplex or map uplink control information (UCI) from the secondary component carrier with a physical uplink shared channel (PUSCH) transmission on the primary component carrier during one or more uplink slots. In some cases, however, the UE may identify that uplink transmission switching is to occur from the primary component carrier to the secondary component carrier prior to the transmission of the UCI. In such cases, there is no PUSCH transmission on the primary component carrier with which to multiplex the UCI on the secondary component carrier.

To accommodate the uplink transmission switching, the UE may modify the mapping of the UCI. In a first example, the UE may drop the UCI on the secondary component carrier. In a second example, the UE may modify the mapping of the UCI such that the UCI is multiplexed with a set of subsequent uplink slots on the primary component carrier. In a third example, the UE may transmit the UCI on a subsequent uplink slot on a PUSCH of the secondary component carrier.

Particular aspects of the subject matter described herein may be implemented to realize one or more advantages. The described techniques may support improvements in techniques for UCI transmission in cases where uplink transmission switching is identified. In some examples, the techniques may allow for increased reliability for communications between a UE and a base station operating in an inter-band carrier aggregation setting. For example, the UE may more reliably transmit UCI with increased flexibility for modifying the mapping of the UCI between component carriers. In addition, the techniques may increase data throughput and resource utilization for the UE supporting uplink transmission switching. As such, supported techniques may include improved network operations and, in some examples, may promote increased communications efficiency, among other benefits.

Aspects of the disclosure are initially described in the context of wireless communications systems. Aspects of the disclosure are further illustrated by and described with reference to apparatus diagrams, system diagrams, UCI mapping configurations, a process flow, and flowcharts that relate to uplink control information mapping for uplink transmission switching.

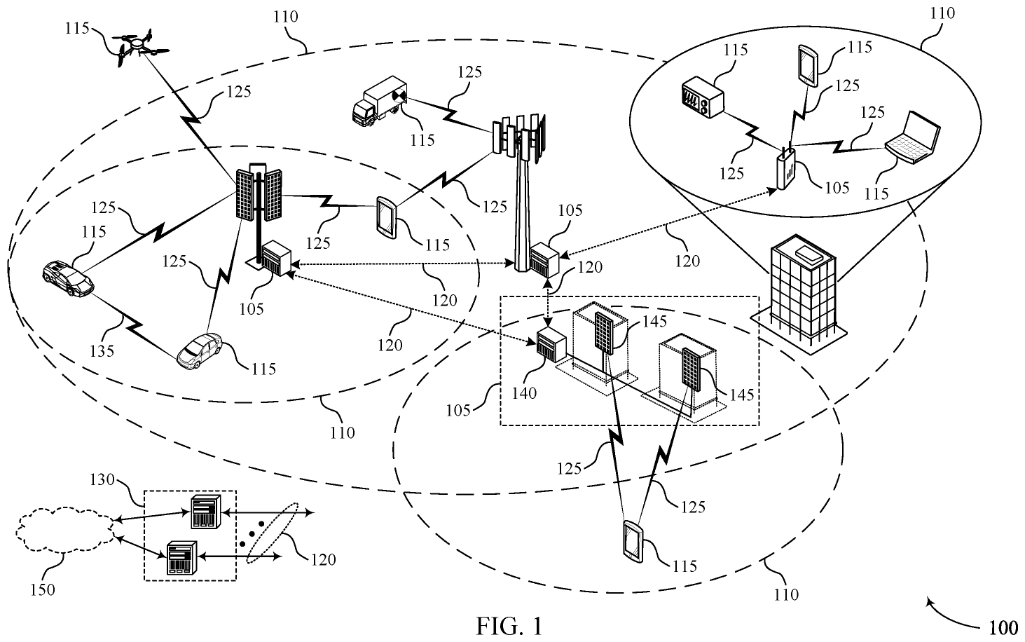

FIG. 1 illustrates an example of a wireless communications system 100 that supports uplink control information mapping for uplink transmission switching in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Wireless communications system 100 may support inter-band carrier aggregation, which enables a UE 115 to operate on two different operating frequency bands. In some cases, the UE 115 may be configured to perform dual uplink transmissions on the two different operating frequency bands. The UE 115 may communicate on a primary cell associated with a primary component carrier and a secondary cell associated with a secondary component carrier using a number of specified uplink and downlink slots of the carrier. In addition, the UE 115 may support uplink transmission switching between uplink slots for each carrier to increase throughput and uplink performance. For example, the UE 115 may switch between the two different operating bands where a first uplink transmission may be fixed on the primary component carrier, and second uplink transmission may be switched between the primary component carrier and the secondary component carrier.

In some examples, the UE 115 may multiplex or map UCI from the secondary component carrier with a PUSCH transmission on the primary component carrier during an uplink transmission opportunity. In some such cases, however, the UE 115 may identify that uplink transmission switching is to occur from the primary component carrier to the secondary component carrier prior to the transmission of the UCI, and the UE 115 may modify the mapping of the UCI. In a first example of such modification, the UE 115 may drop the UCI on the secondary component carrier. In a second example, the UE 115 may multiplex the UCI with a set of subsequent uplink slots on the primary component carrier. In a third example, the UE 115 may transmit the UCI on a PUSCH using a next available slot of the secondary component carrier.

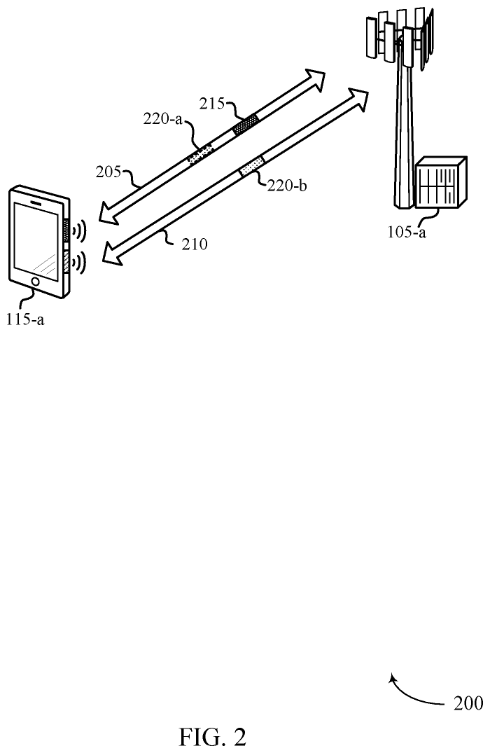

FIG. 2 illustrates an example of a wireless communications system 200 that supports uplink control information mapping for uplink transmission switching in accordance with aspects of the present disclosure. For example, wireless communications system 200 contains a UE 115-a in communication with base station 105-a, which may be examples of a UE 115 and base station 105 described with reference to FIG. 1.

Wireless communications system 200 may support various carrier aggregation configurations to increase network coverage and bandwidth. In some examples, wireless communications system 200 may support inter-band carrier aggregation, which aggregates the carriers of two different operating frequency bands. Such inter-band carrier aggregation may be supported in both FDD and TDD modes, for example, a first carrier (e.g., carrier 1) may be associated with FDD, and a second carrier (e.g., carrier 2) may be associated with TDD. To operate in accordance with the inter-band carrier aggregation configuration, and to comply with various thermal and power consumption limitations, the UE 115-a may perform uplink transmissions on two separate component carriers or cells using different transmission chains. For example, the UE 115-a may transmit a first uplink transmission on a first operating frequency band, and a second uplink transmission on a second operating frequency band.

In addition, the UE 115-a may operate on a number of different serving cells according to the carrier aggregation configuration. For example, a first serving cell may be a primary cell associated with a primary component carrier 205 (e.g., carrier 2) which supports TDD communications. A second serving cell may be a secondary cell associated with a secondary component carrier 210 (e.g., carrier 1) which supports FDD communications. In some cases, the carriers supported on each cell (e.g., carrier 1 and carrier 2) may be switched. The UE 115-a may perform communications in accordance with a scheduling of each carrier, for example, the UE 115-a may receive downlink data during a number of specified downlink slots, and the UE 115-a may transmit uplink data in a number of specified uplink slots.

To further enhance uplink performance, the UE 115-a may support uplink transmission switching between uplink slots for each carrier. For example, the UE 115-a may switch between the two different operating bands to enable uplink MIMO on a primary cell, and to increase resource utilization and throughput for the UE 115-a. In an uplink transmission switching procedure, the UE 115-a may use one transmitting channel for transmitting a first carrier 215 (e.g., using carrier 1) or a second carrier (e.g., using carrier 2), and may use another transmitting channel for transmitting only the second carrier 220-b (e.g., carrier 2). In such cases, a first uplink transmission may be fixed on the secondary carrier (e.g., a TDD carrier), and second uplink transmission may be switched between the first carrier and the second carrier (e.g., an FDD carrier or a TDD carrier). The UE 115-a may switch between communications on the component carriers 205 and 210 to increase the number of uplink transmission opportunities available for the UE 115-a.

In some cases, the UE 115-a may identify UCI (including channel quality information (CQI) and HARQ information) to send to the base station 105-a. In some examples, the UE 115-a may support simultaneous (e.g., overlapped) transmission of an physical uplink control channel (PUCCH) and a PUSCH such that the UE 115-a may multiplex or map the UCI from the secondary component carrier (e.g., carrier 1) with a PUSCH transmission on the primary component carrier (e.g., carrier 2) during an uplink transmission opportunity. In some cases, however, the UE 115-a may identify an uplink transmission switching that is to occur from the primary component carrier to the secondary component carrier prior to the transmission of the PUSCH on the primary component carrier. In such cases, there is no PUSCH transmission on the primary component carrier with which to multiplex the UCI on the secondary component carrier.

In the case of an identified uplink transmission switching, the UE 115-a may determine to modify the mapping of the UCI. In a first example, the UE 115-a may drop (e.g., refrain from transmitting) the UCI on the secondary component carrier. In a second example, the UE 115-a may modify the mapping of the UCI such that the UCI is multiplexed with a set of subsequent uplink slots on the primary component carrier. For example, if the uplink transmission switching the UCI was to be multiplexed with uplink slots 8 and 9 of the primary component carrier and the UE 115-a identifies an uplink transmission switching before slots 8 and 9, the UE 115-a may modify the mapping of the UCI such that the UCI is multiplexed with slots 18 and 19 of the primary component carrier. In a third example, the UE 115-a may transmit the UCI on a subsequent uplink slot of the secondary component carrier. For example, if the UCI was to be transmitted in slot 4 of the secondary component carrier, and the UE 115-a identifies an uplink transmission switching, the UE 115-a may delay the transmission of the UCI to slot 5 of the secondary component carrier.

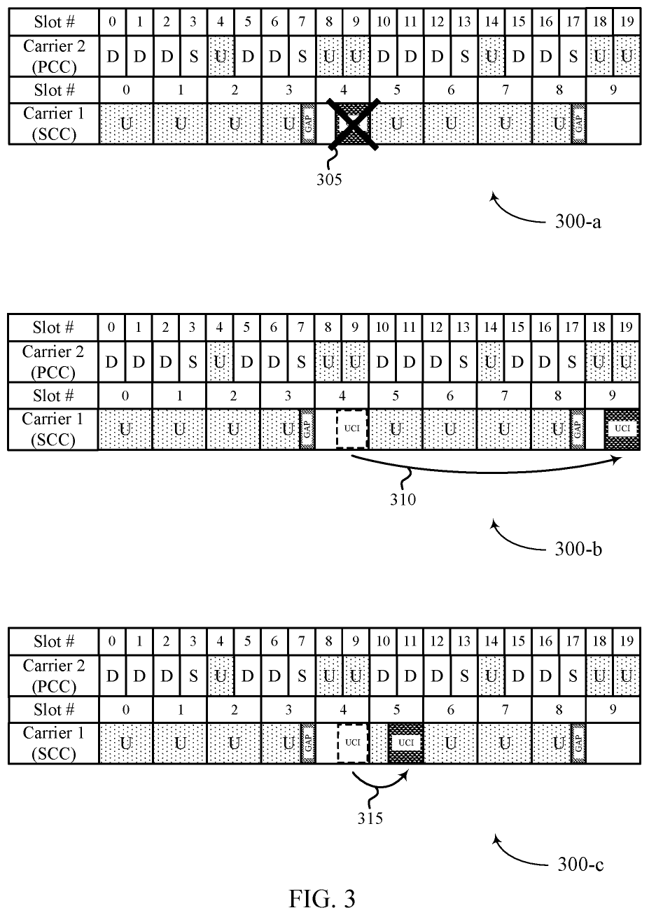

FIG. 3 illustrates an example of UCI mapping configurations 300-a, 300-b, and 300-c that support uplink control information mapping for uplink transmission switching in accordance with aspects of the present disclosure. For example, the UCI mapping configurations 300-a, 300-b, and 300-c may be performed by a UE, which may be an example of UE 115 described with reference to FIGS. 1 and 2.

UCI mapping configurations 300-a, 300-b, and 300-c may be associated with an inter-band carrier aggregation configuration which supports overlapping PUSCH and PUCCH transmissions from a UE in a wireless communications system. The UCI mapping configurations may provide scheduling for uplink and downlink communications. For example, the UCI mapping configurations 300-a, 300-b, and 300-c identify a primary component carrier (PCC) which operates in a TDD mode, and contains a number of slots (e.g., slots 0 through 19), including specified uplink slots (U), downlink slots (D), and switch period slots (S). The UCI mapping configurations 300-a, 300-b, and 300-c further identify a secondary component carrier (SCC) which operates in an FDD mode, and contains a number of slots (e.g., slots 0 through 9), including specified uplink slots (U), and gap durations (GAP).

In some examples, a UE may identify a PUSCH transmission that is scheduled to be transmitted on consecutive uplink slots (e.g., slots 8 and 9) of the primary component carrier, and the UE may multiplex or map UCI of the secondary component carrier to the PUSCH transmission of the primary component carrier. In some cases, however, the UE may identify an uplink transmission switching that is to occur before the PUSCH transmission, such that there is no transmission on the primary component carrier with which to map the UCI.

In accordance with UCI mapping configuration 300-a, at 305 the UE may drop (e.g., refrain from transmitting) the UCI. For example, overlapped PUCCH and PUSCH on the primary cell and the secondary cell, the UE does not map the UCI of secondary cell to consecutive uplink slots of primary cell when there is an expected transmission switching (and no uplink transmission on the primary cell in the consecutive uplink slots).

In accordance with UCI mapping configuration 300-b, at 310 the UE may modify the mapping of the UCI such that the UCI is multiplexed with a set of subsequent uplink slots on the primary component carrier. For example, for overlapped PUCCH and PUSCH on the primary cell and the secondary cell, the UE may map the UCI of secondary cell to the next available uplink slots of the primary cell when there is an expected transmission switching (and no uplink transmission on the primary cell in the consecutive uplink slots). In UCI mapping configuration 300-b, the UE may modify the mapping of the UCI such that the UCI is multiplexed with slots 18 and 19 of the primary component carrier.

In accordance with UCI mapping configuration 300-c, at 315 the UE may modify the mapping of the UCI such that the UCI is not multiplexed with an uplink transmission of the primary cell, but the UE may delay the transmission of the UCI to a subsequent uplink slot of the secondary cell. For example, for overlapped PUCCH and PUSCH on primary cell and the secondary cell, the UE does not map the UCI of the secondary cell to the primary cell when there is an expected transmission switching (and no uplink transmission on the primary cell in the consecutive uplink slots). In UCI mapping configuration 300-c, the UE may map the UCI to a PUSCH in the next available uplink slot of the same component carrier. For example, the UE may delay the transmission of the UCI from slot 4 to slot 5.

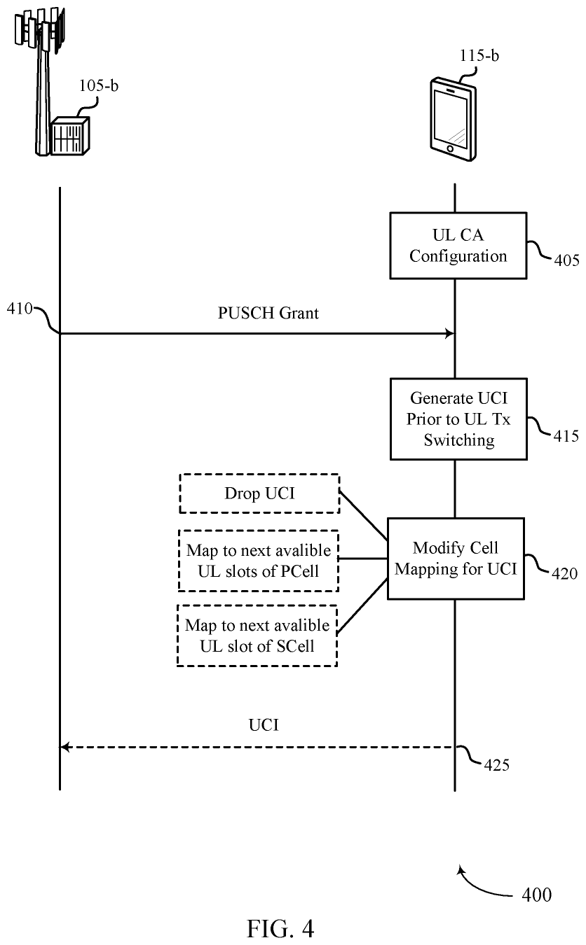

FIG. 4 illustrates an example of a process flow 400 that supports uplink control information mapping for uplink transmission switching in accordance with aspects of the present disclosure. In some examples, process flow 400 may implement aspects of wireless communication systems 100 and 200. The process flow 400 includes UE 115-b and base station 105-b, which may be examples of the corresponding devices described with reference to FIGS. 1 and 2. Alternative examples of the following may be implemented, where some steps are performed in a different order than described or are not performed at all. In some cases, steps may include additional features not mentioned below, or further steps may be added. In addition, while process flow 400 shows processes between base station 105-b and a UE 115-a, it should be understood that these processes may occur between any number of network devices.

At 405, the UE 115-b may be operating in accordance with an uplink carrier aggregation configuration on a primary cell and a secondary cell served by the base station 105-b. In some examples, the uplink carrier aggregation configuration is an inter-band carrier aggregation configuration supporting dual uplink transmission at the UE 115-b. The dual uplink transmission may support at least one uplink transmission on one or more component carriers (e.g., a primary component carrier and a secondary component carrier) associated with the primary cell and the secondary cell. In the example of inter-band carrier aggregation, the primary cell may be associated with a first carrier frequency and the secondary cell may be associated with a second carrier frequency (different from the first carrier frequency). In addition, the primary cell may be the primary cell of a primary cell group or of a secondary cell group. The secondary cell may be can be a primary SpCell, or a secondary cell in a secondary cell group, accordingly. The primary cell and the secondary cell may be part of the same cell group or a common cell group.

At 410, the UE 115-b may receive a grant for a PUSCH that is mapped to the primary cell on a first set of uplink slots. In some examples, the first set of uplink slots may be a set of consecutive uplink slots.

At 415, the UE 115-b may generate UCI that is mapped to the secondary cell (e.g., the UCI of the secondary cell is multiplexed with the PUSCH of the primary cell), where the PUSCH that is mapped to the primary cell is scheduled to overlap with the UCI, and uplink transmission switching is scheduled to occur from the primary cell to the secondary cell prior to a transmission of the UCI. In such cases of uplink transmission switching, the UE 115-b may drop the PUSCH transmission on the first set of uplink slots of the primary cell (e.g., no PUSCH transmission occurs on the primary cell).

At 420, the UE 115-b may modify a cell mapping for the transmission of the UCI based on the identified uplink transmission switching. In some examples, modifying the cell mapping may include dropping the transmission of the UCI, where the transmission of the UCI on the secondary cell is dropped for consecutive uplink slots of the primary cell. In some examples, modifying the cell mapping may include mapping the transmission of the UCI on the secondary cell to a second set of uplink slots of the primary cell different from the first set of uplink slots, where the second set of uplink slots are a subsequent set of consecutive slots that are available for transmission of the UCI. In some other examples, modifying the cell mapping may include mapping the transmission of the UCI of the secondary cell from a first uplink slot of the secondary cell to a second uplink slot of the secondary cell, where the second uplink slot of the secondary cell is a subsequent slot that is available for transmission of the UCI.

At 425, the UE 115-b may optionally transmit the UCI in accordance with the modified UCI mapping. In some examples, the UE 115-a may not transmit the UCI based on the modified mapping.

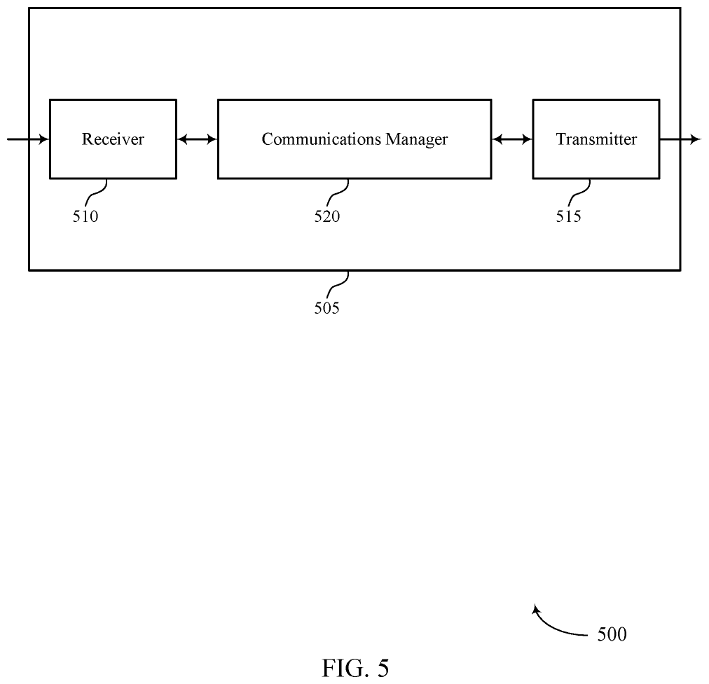

FIG. 5 shows a block diagram 500 of a device 505 that supports uplink control information mapping for uplink transmission switching in accordance with aspects of the present disclosure. The device 505 may be an example of aspects of a UE 115 as described herein. The device 505 may include a receiver 510, a transmitter 515, and a communications manager 520. The device 505 may also include at least one processor. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink control information mapping for uplink transmission switching). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink control information mapping for uplink transmission switching). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of uplink control information mapping for uplink transmission switching as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include at least one processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for operating in accordance with an uplink carrier aggregation configuration on a primary cell and a secondary cell. The communications manager 520 may be configured as or otherwise support a means for receiving a grant for an uplink shared channel transmission mapped to the primary cell on a first set of uplink slots. The communications manager 520 may be configured as or otherwise support a means for generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The communications manager 520 may be configured as or otherwise support a means for modifying a cell mapping for the transmission of the uplink control information based on the uplink transmission switching.

By including or configuring the communications manager 520 in accordance with examples as described herein, the device 505 (e.g., at least one processor controlling or otherwise coupled to the receiver 510, the transmitter 515, the communications manager 520, or a combination thereof) may support techniques for modifying the mapping of UCI based on an identified uplink transmission switching. In some examples, communications manager 520 may be implemented as an integrated circuit or chipset for a mobile device modem, and the receiver 510 and transmitter 515 may be implemented as analog components (e.g., amplifiers, filters, and antennas) coupled with the mobile device modem to enable wireless transmission and reception.

The communications manager 520 as described herein may be implemented to realize one or more potential advantages. At least one implementation may enable communications manager 520 to effectively modify the mapping of the UCI based on an identified uplink switching. For example, the communications manager 520 may be configured to drop the UCI, or delay the transmission of the UCI on one or more component carriers.

Based on implementing the techniques as described herein, one or more processors of the device 505 (e.g., processor(s) controlling or incorporated with one or more of receiver 510, communications manager 520, and transmitter 515) may effectively increase device throughput and reliability of the transmission of the UCI. In addition, the techniques described herein may provide for more efficient utilization of communication resources due to the uplink transmission switching.

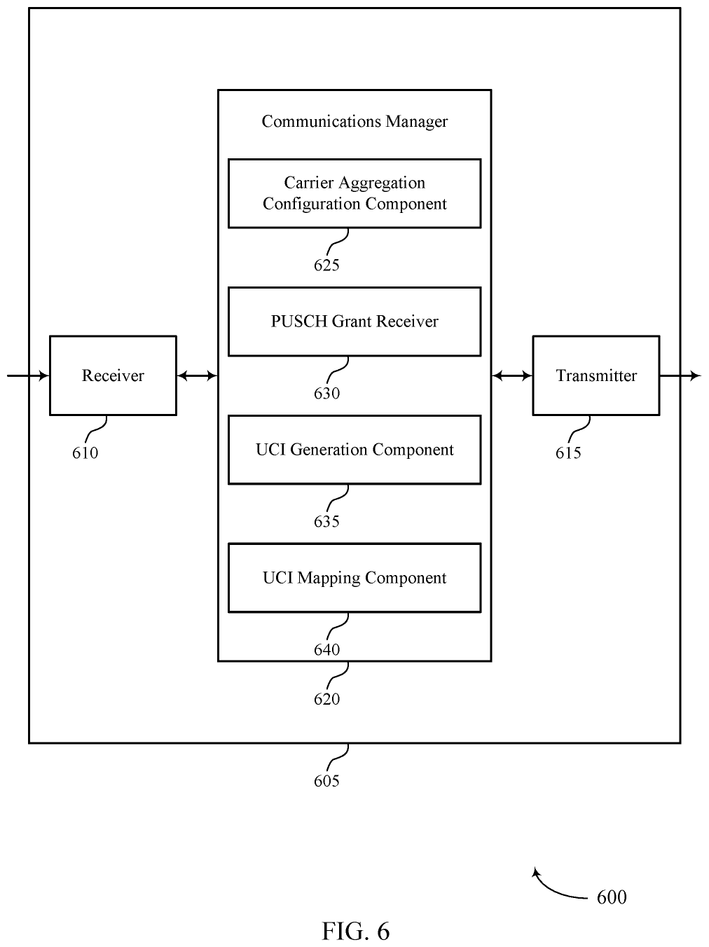

FIG. 6 shows a block diagram 600 of a device 605 that supports uplink control information mapping for uplink transmission switching in accordance with aspects of the present disclosure. The device 605 may be an example of aspects of a device 505 or a UE 115 as described herein. The device 605 may include a receiver 610, a transmitter 615, and a communications manager 620. The device 605 may also include at least one processor. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink control information mapping for uplink transmission switching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink control information mapping for uplink transmission switching). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of uplink control information mapping for uplink transmission switching as described herein. For example, the communications manager 620 may include a carrier aggregation configuration component 625, an PUSCH grant receiver 630, a UCI generation component 635, a UCI mapping component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The carrier aggregation configuration component 625 may be configured as or otherwise support a means for operating in accordance with an uplink carrier aggregation configuration on a primary cell and a secondary cell. The PUSCH grant receiver 630 may be configured as or otherwise support a means for receiving a grant for an uplink shared channel transmission mapped to the primary cell on a first set of uplink slots. The UCI generation component 635 may be configured as or otherwise support a means for generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The UCI mapping component 640 may be configured as or otherwise support a means for modifying a cell mapping for the transmission of the uplink control information based on the uplink transmission switching.

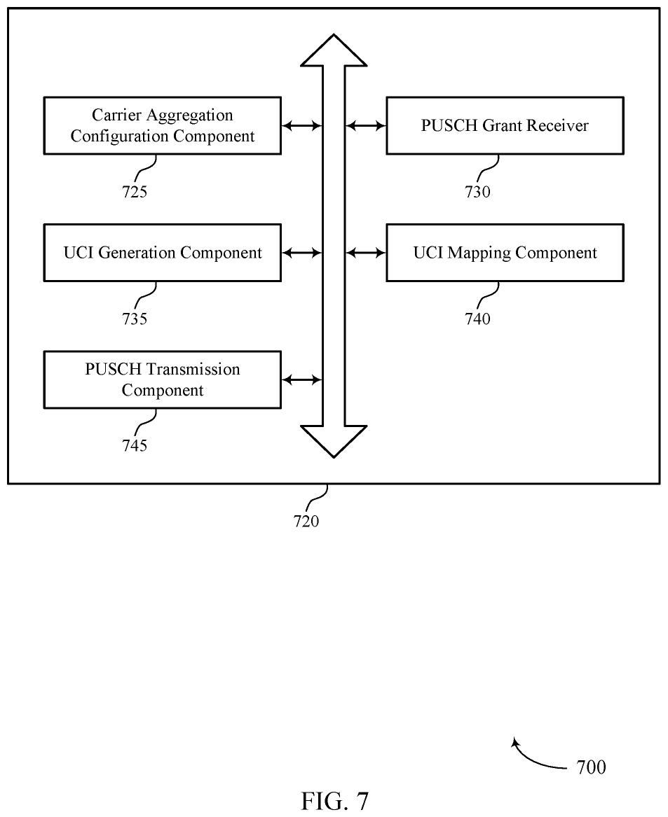

FIG. 7 shows a block diagram 700 of a communications manager 720 that supports uplink control information mapping for uplink transmission switching in accordance with aspects of the present disclosure. The communications manager 720 may be an example of aspects of a communications manager 520, a communications manager 620, or both, as described herein. The communications manager 720, or various components thereof, may be an example of means for performing various aspects of uplink control information mapping for uplink transmission switching as described herein. For example, the communications manager 720 may include a carrier aggregation configuration component 725, an PUSCH grant receiver 730, a UCI generation component 735, a UCI mapping component 740, an PUSCH transmission component 745, or any combination thereof. Each of these components may communicate, directly or indirectly, with one another (e.g., via one or more buses).

The communications manager 720 may support wireless communications at a UE in accordance with examples as disclosed herein. The carrier aggregation configuration component 725 may be configured as or otherwise support a means for operating in accordance with an uplink carrier aggregation configuration on a primary cell and a secondary cell. The PUSCH grant receiver 730 may be configured as or otherwise support a means for receiving a grant for an uplink shared channel transmission mapped to the primary cell on a first set of uplink slots. The UCI generation component 735 may be configured as or otherwise support a means for generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The UCI mapping component 740 may be configured as or otherwise support a means for modifying a cell mapping for the transmission of the uplink control information based on the uplink transmission switching.

In some examples, to support modifying the cell mapping for the transmission of the uplink control information, the UCI mapping component 740 may be configured as or otherwise support a means for dropping the transmission of the uplink control information on the secondary cell based on the uplink transmission switching. In some examples, the transmission of the uplink control information on the secondary cell is dropped for consecutive uplink slots of the primary cell.

In some examples, to support modifying the cell mapping for the transmission of the uplink control information, the UCI mapping component 740 may be configured as or otherwise support a means for mapping the transmission of the uplink control information on the secondary cell to a second set of uplink slots of the primary cell different from the first set of uplink slots based on the uplink transmission switching. In some examples, the second set of uplink slots include a subsequent set of consecutive slots that are available for transmission of the uplink control information.

In some examples, to support modifying the cell mapping for the transmission of the uplink control information, the UCI mapping component 740 may be configured as or otherwise support a means for mapping the transmission of the uplink control information of the secondary cell from a first uplink slot of the secondary cell to a second uplink slot of the secondary cell based on the uplink transmission switching. In some examples, the second uplink slot of the secondary cell is a subsequent slot that is available for transmission of the uplink control information.

In some examples, to support uplink transmission switching, the PUSCH transmission component 745 may be configured as or otherwise support a means for dropping the uplink shared channel transmission on the first set of uplink slots of the primary cell. In some examples, the uplink carrier aggregation configuration is an inter-band carrier aggregation configuration supporting dual uplink transmission.

In some examples, the dual uplink transmission includes at least one uplink transmission on one or more component carriers associated with the primary cell and the secondary cell. In some examples, the uplink control information of the secondary cell is multiplexed with the uplink shared channel transmission of the primary cell. In some examples, the primary cell is associated with a first carrier frequency and the secondary cell is associated with a second carrier frequency that is different from the first carrier frequency. In some examples, the primary cell and the secondary cell are associated with a common cell group.

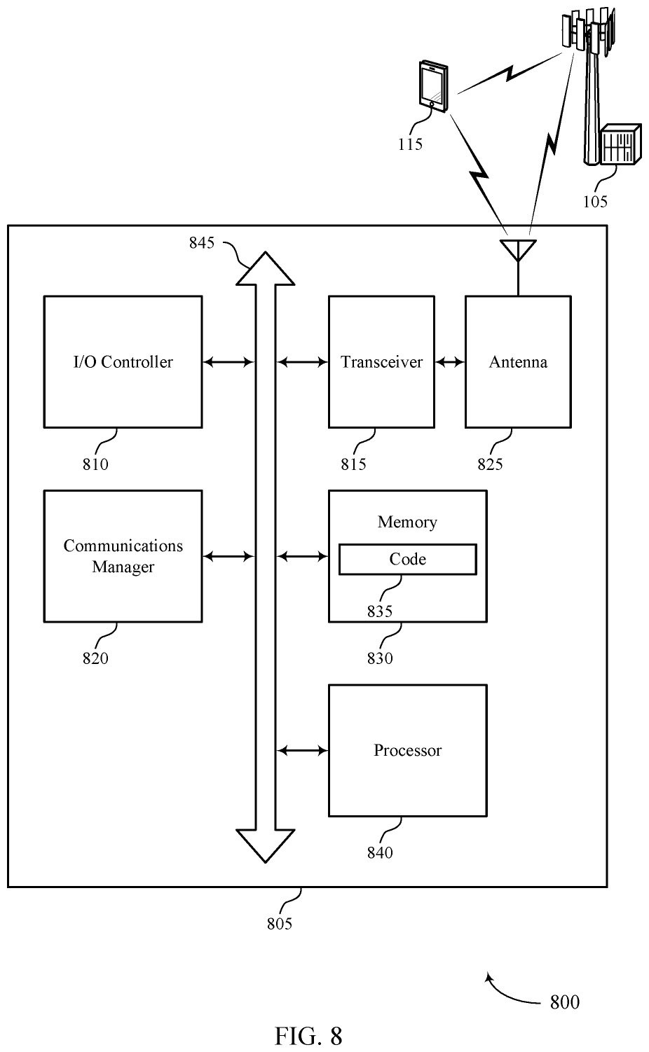

FIG. 8 shows a diagram of a system 800 including a device 805 that supports uplink control information mapping for uplink transmission switching in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of at least one processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting uplink control information mapping for uplink transmission switching). For example, the device 805 or a component of the device 805 may include at least one processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for operating in accordance with an uplink carrier aggregation configuration on a primary cell and a secondary cell. The communications manager 820 may be configured as or otherwise support a means for receiving a grant for an uplink shared channel transmission mapped to the primary cell on a first set of uplink slots. The communications manager 820 may be configured as or otherwise support a means for generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The communications manager 820 may be configured as or otherwise support a means for modifying a cell mapping for the transmission of the uplink control information based on the uplink transmission switching.

By including or configuring the communications manager 820 in accordance with examples as described herein, the device 805 may support techniques for improved communication reliability, specifically reliability for transmissions of UCI during intra-band carrier aggregation and uplink transmission switching. In addition, the device 805 may support techniques for improved user experience related to the increased reliability, more efficient utilization of communication resources, and improved coordination between devices in the network.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of uplink control information mapping for uplink transmission switching as described herein, or the processor 840 and the memory 830 may be otherwise configured to perform or support such operations.

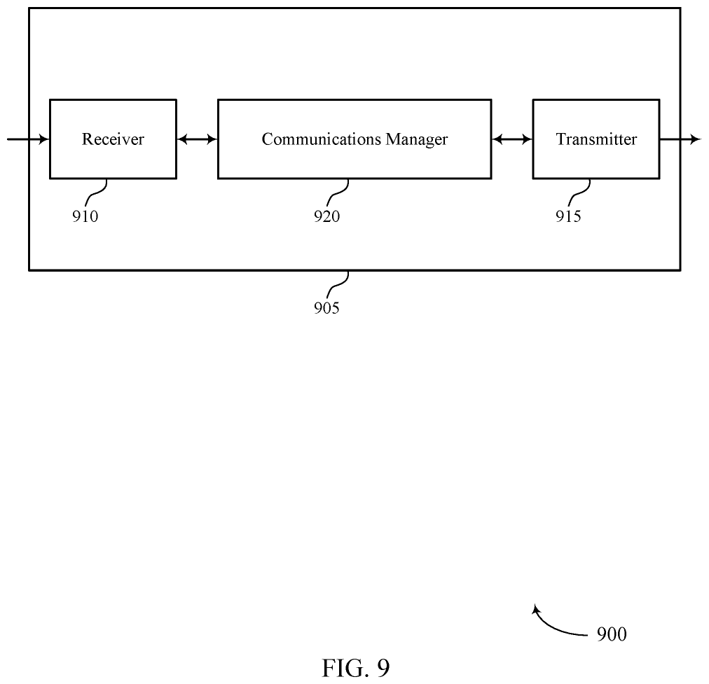

FIG. 9 shows a block diagram 900 of a device 905 that supports uplink control information mapping for uplink transmission switching in accordance with aspects of the present disclosure. The device 905 may be an example of aspects of a base station 105 as described herein. The device 905 may include a receiver 910, a transmitter 915, and a communications manager 920. The device 905 may also include at least one processor. Each of these components may be in communication with one another (e.g., via one or more buses).

The receiver 910 may provide a means for receiving information such as packets, user data, control information, or any combination thereof associated with various information channels (e.g., control channels, data channels, information channels related to uplink control information mapping for uplink transmission switching). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to uplink control information mapping for uplink transmission switching). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of uplink control information mapping for uplink transmission switching as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include at least one processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by at least one processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information. The communications manager 920 may be configured as or otherwise support a means for receiving, from the UE, the uplink control information in accordance with a modified cell mapping of the UE based on the uplink transmission switching.

By including or configuring the communications manager 920 in accordance with examples as described herein, the device 905 (e.g., at least one processor controlling or otherwise coupled to the receiver 910, the transmitter 915, the communications manager 920, or a combination thereof) may support techniques for more efficient processing, increased reliability and flexibility, and more efficient utilization of communication resources.

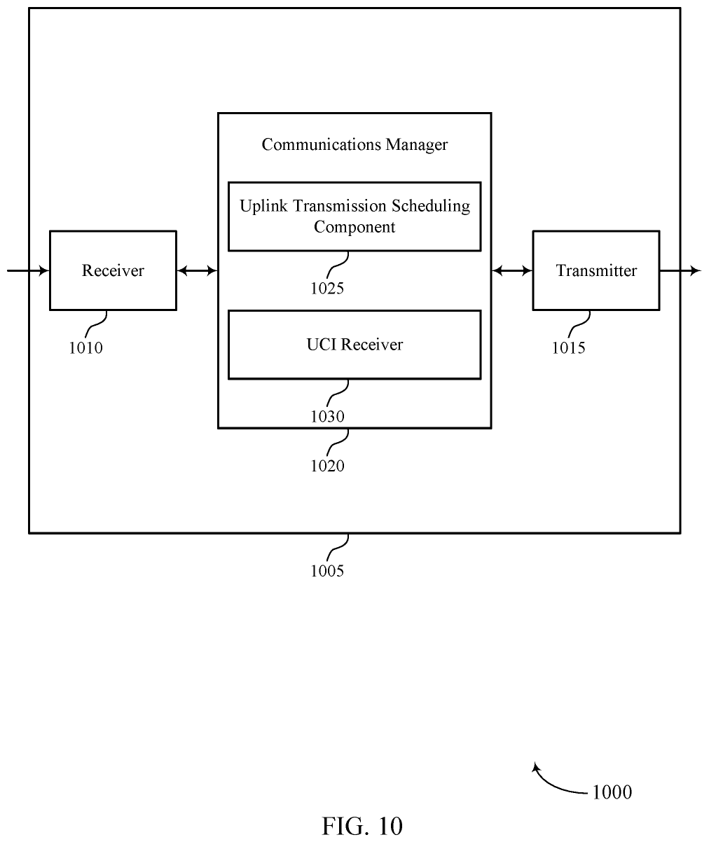

FIG. 10 shows a block diagram 1000 of a device 1005 that supports uplink control information mapping for uplink transmission switching in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include at least one processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to uplink control information mapping for uplink transmission switching). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to uplink control information mapping for uplink transmission switching). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of uplink control information mapping for uplink transmission switching as described herein. For example, the communications manager 1020 may include an uplink transmission scheduling component 1025 a UCI receiver 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The uplink transmission scheduling component 1025 may be configured as or otherwise support a means for transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information. The UCI receiver 1030 may be configured as or otherwise support a means for receiving, from the UE, the uplink control information in accordance with a modified cell mapping of the UE based on the uplink transmission switching.

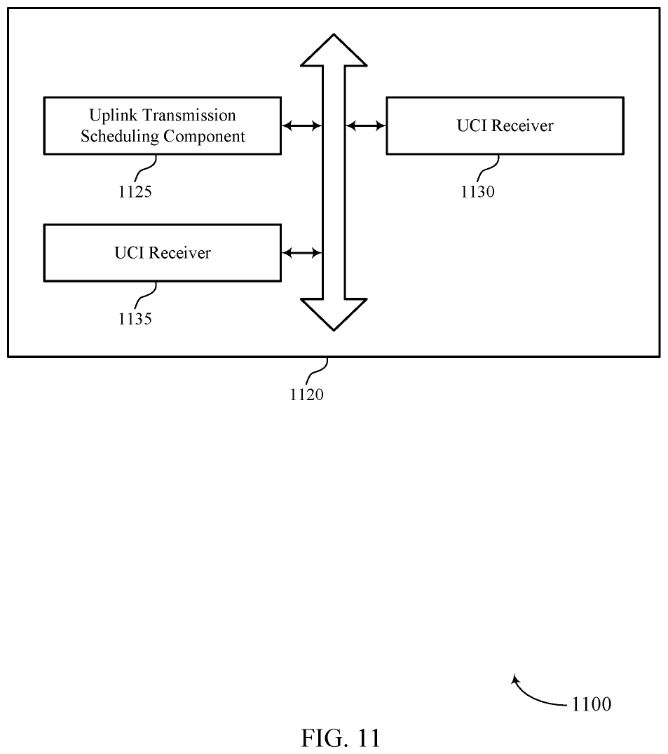

FIG. 11 shows a block diagram 1100 of a communications manager 1120 that supports uplink control information mapping for uplink transmission switching in accordance with aspects of the present disclosure. The communications manager 1120 may be an example of aspects of a communications manager 920, a communications manager 1020, or both, as described herein. The communications manager 1120, or various components thereof, may be an example of means for performing various aspects of uplink control information mapping for uplink transmission switching as described herein. For example, the communications manager 1120 may include an uplink transmission scheduling component 1125, a UCI receiver 1130, a UCI receiver 1135, or any combination thereof. Each of these components may communicate, directly or indirectly, with one another (e.g., via one or more buses).

The communications manager 1120 may support wireless communications at a base station in accordance with examples as disclosed herein. The uplink transmission scheduling component 1125 may be configured as or otherwise support a means for transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information. The UCI receiver 1130 may be configured as or otherwise support a means for receiving, from the UE, the uplink control information in accordance with a modified cell mapping of the UE based on the uplink transmission switching.

In some examples, the UCI receiver 1135 may be configured as or otherwise support a means for receiving the transmission of the uplink control information on a second set of uplink slots of the primary cell different from the first set of uplink slots in accordance with the modified cell mapping of the UE. In some examples, the second set of uplink slots include a subsequent set of consecutive slots that are available for transmission of the uplink control information.

In some examples, to support uplink transmission switching, the uplink transmission scheduling component 1125 may be configured as or otherwise support a means for dropping the grant for the uplink shared channel transmission on the first set of uplink slots of the primary cell.

In some examples, the base station supports inter-band carrier aggregation for receiving uplink transmissions from the UE. In some examples, the uplink control information is multiplexed with the uplink shared channel transmission of the primary cell. In some examples, the primary cell is associated with a first carrier frequency and the secondary cell is associated with a second carrier frequency that is different from the first carrier frequency. In some examples, the primary cell and the secondary cell are associated with a common cell group.

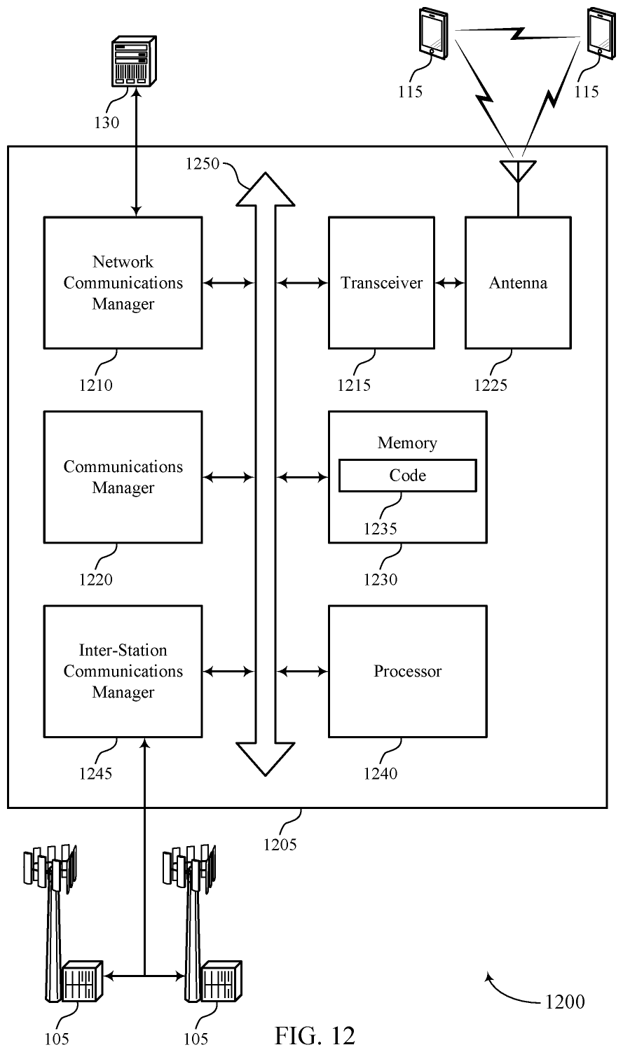

FIG. 12 shows a diagram of a system 1200 including a device 1205 that supports uplink control information mapping for uplink transmission switching in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting uplink control information mapping for uplink transmission switching). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information. The communications manager 1220 may be configured as or otherwise support a means for receiving, from the UE, the uplink control information in accordance with a modified cell mapping of the UE based on the uplink transmission switching.

By including or configuring the communications manager 1220 in accordance with examples as described herein, the device 1205 may support techniques for improved communication reliability, more specifically related to the transmission of control information such as channel status information (CSI) and HARQ information. In addition, the device 1205 may support techniques for improved user experience related to increased reliability and efficiency, more efficient utilization of communication resources, improved coordination between devices, and higher data throughput.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of uplink control information mapping for uplink transmission switching as described herein, or the processor 1240 and the memory 1230 may be otherwise configured to perform or support such operations.

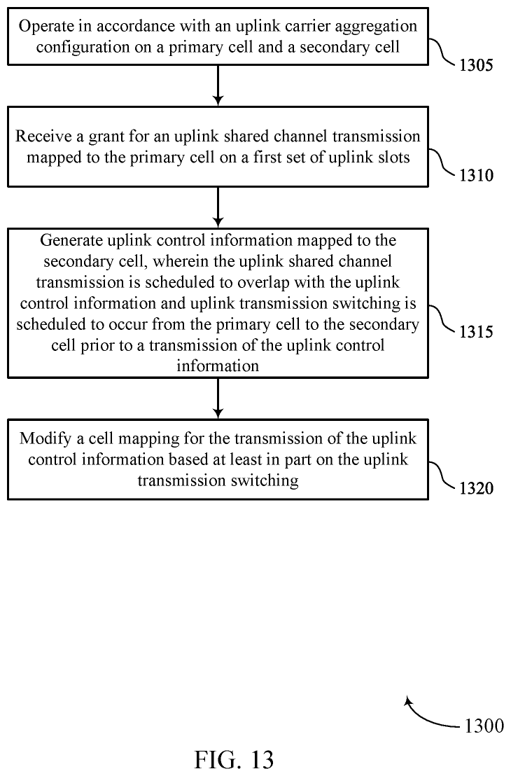

FIG. 13 shows a flowchart illustrating a method 1300 that supports uplink control information mapping for uplink transmission switching in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include operating in accordance with an uplink carrier aggregation configuration on a primary cell and a secondary cell. The operations of 1305 may be performed in accordance with examples as disclosed herein. In some examples, aspects of the operations of 1305 may be performed by a carrier aggregation configuration component 725 as described with reference to FIG. 7.

At 1310, the method may include receiving a grant for an uplink shared channel transmission mapped to the primary cell on a first set of uplink slots. The operations of 1310 may be performed in accordance with examples as disclosed herein. In some examples, aspects of the operations of 1310 may be performed by an PUSCH grant receiver 730 as described with reference to FIG. 7.

At 1315, the method may include generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The operations of 1315 may be performed in accordance with examples as disclosed herein. In some examples, aspects of the operations of 1315 may be performed by a UCI generation component 735 as described with reference to FIG. 7.

At 1320, the method may include modifying a cell mapping for the transmission of the uplink control information based on the uplink transmission switching. The operations of 1320 may be performed in accordance with examples as disclosed herein. In some examples, aspects of the operations of 1320 may be performed by a UCI mapping component 740 as described with reference to FIG. 7.

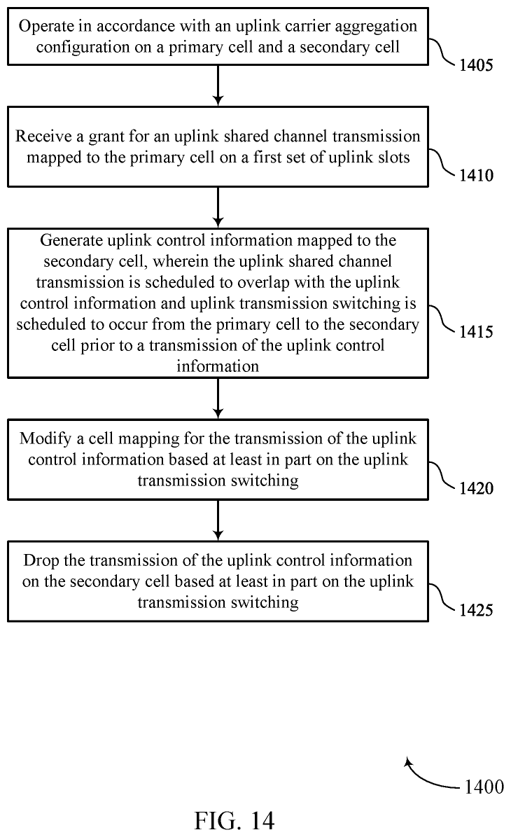

FIG. 14 shows a flowchart illustrating a method 1400 that supports uplink control information mapping for uplink transmission switching in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include operating in accordance with an uplink carrier aggregation configuration on a primary cell and a secondary cell. The operations of 1405 may be performed in accordance with examples as disclosed herein. In some examples, aspects of the operations of 1405 may be performed by a carrier aggregation configuration component 725 as described with reference to FIG. 7.

At 1410, the method may include receiving a grant for an uplink shared channel transmission mapped to the primary cell on a first set of uplink slots. The operations of 1410 may be performed in accordance with examples as disclosed herein. In some examples, aspects of the operations of 1410 may be performed by an PUSCH grant receiver 730 as described with reference to FIG. 7.

At 1415, the method may include generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The operations of 1415 may be performed in accordance with examples as disclosed herein. In some examples, aspects of the operations of 1415 may be performed by a UCI generation component 735 as described with reference to FIG. 7.

At 1420, the method may include modifying a cell mapping for the transmission of the uplink control information based on the uplink transmission switching. The operations of 1420 may be performed in accordance with examples as disclosed herein. In some examples, aspects of the operations of 1420 may be performed by a UCI mapping component 740 as described with reference to FIG. 7.

At 1425, the method may include dropping the transmission of the uplink control information on the secondary cell based on the uplink transmission switching. The operations of 1425 may be performed in accordance with examples as disclosed herein. In some examples, aspects of the operations of 1425 may be performed by a UCI mapping component 740 as described with reference to FIG. 7.

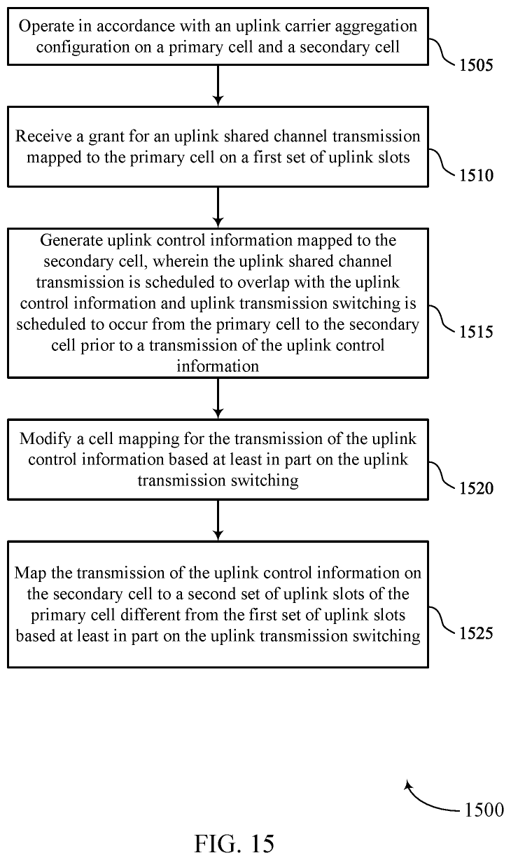

FIG. 15 shows a flowchart illustrating a method 1500 that supports uplink control information mapping for uplink transmission switching in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include operating in accordance with an uplink carrier aggregation configuration on a primary cell and a secondary cell. The operations of 1505 may be performed in accordance with examples as disclosed herein. In some examples, aspects of the operations of 1505 may be performed by a carrier aggregation configuration component 725 as described with reference to FIG. 7.

At 1510, the method may include receiving a grant for an uplink shared channel transmission mapped to the primary cell on a first set of uplink slots. The operations of 1510 may be performed in accordance with examples as disclosed herein. In some examples, aspects of the operations of 1510 may be performed by an PUSCH grant receiver 730 as described with reference to FIG. 7.

At 1515, the method may include generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The operations of 1515 may be performed in accordance with examples as disclosed herein. In some examples, aspects of the operations of 1515 may be performed by a UCI generation component 735 as described with reference to FIG. 7.

At 1520, the method may include modifying a cell mapping for the transmission of the uplink control information based on the uplink transmission switching. The operations of 1520 may be performed in accordance with examples as disclosed herein. In some examples, aspects of the operations of 1520 may be performed by a UCI mapping component 740 as described with reference to FIG. 7.

At 1525, the method may include mapping the transmission of the uplink control information on the secondary cell to a second set of uplink slots of the primary cell different from the first set of uplink slots based on the uplink transmission switching. The operations of 1525 may be performed in accordance with examples as disclosed herein. In some examples, aspects of the operations of 1525 may be performed by a UCI mapping component 740 as described with reference to FIG. 7.

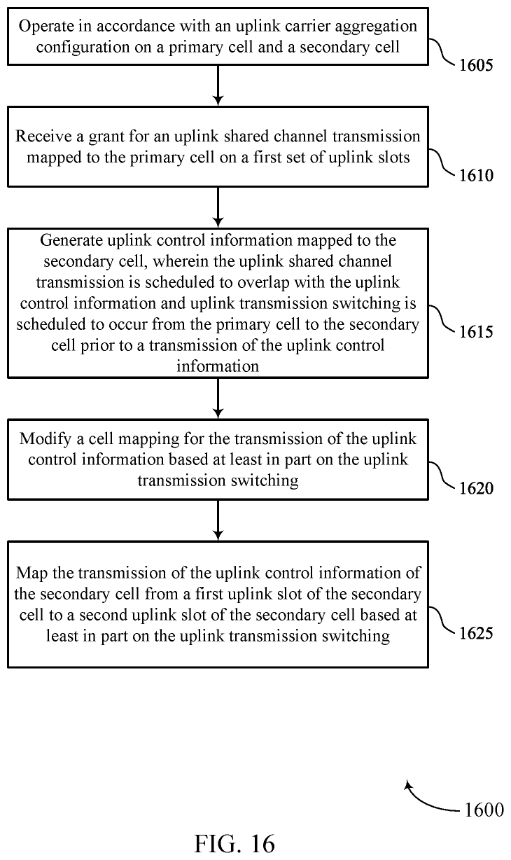

FIG. 16 shows a flowchart illustrating a method 1600 that supports uplink control information mapping for uplink transmission switching in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1605, the method may include operating in accordance with an uplink carrier aggregation configuration on a primary cell and a secondary cell. The operations of 1605 may be performed in accordance with examples as disclosed herein. In some examples, aspects of the operations of 1605 may be performed by a carrier aggregation configuration component 725 as described with reference to FIG. 7.

At 1610, the method may include receiving a grant for an uplink shared channel transmission mapped to the primary cell on a first set of uplink slots. The operations of 1610 may be performed in accordance with examples as disclosed herein. In some examples, aspects of the operations of 1610 may be performed by an PUSCH grant receiver 730 as described with reference to FIG. 7.

At 1615, the method may include generating uplink control information mapped to the secondary cell, where the uplink shared channel transmission is scheduled to overlap with the uplink control information and uplink transmission switching is scheduled to occur from the primary cell to the secondary cell prior to a transmission of the uplink control information. The operations of 1615 may be performed in accordance with examples as disclosed herein. In some examples, aspects of the operations of 1615 may be performed by a UCI generation component 735 as described with reference to FIG. 7.

At 1620, the method may include modifying a cell mapping for the transmission of the uplink control information based on the uplink transmission switching. The operations of 1620 may be performed in accordance with examples as disclosed herein. In some examples, aspects of the operations of 1620 may be performed by a UCI mapping component 740 as described with reference to FIG. 7.

At 1625, the method may include mapping the transmission of the uplink control information of the secondary cell from a first uplink slot of the secondary cell to a second uplink slot of the secondary cell based on the uplink transmission switching. The operations of 1625 may be performed in accordance with examples as disclosed herein. In some examples, aspects of the operations of 1625 may be performed by a UCI mapping component 740 as described with reference to FIG. 7.

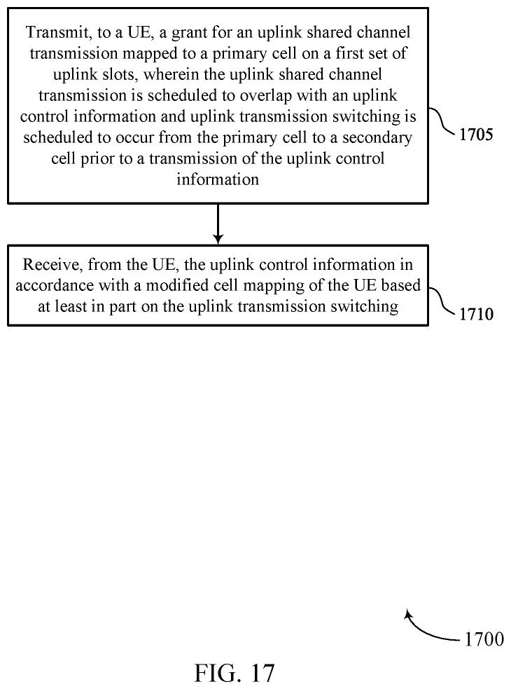

FIG. 17 shows a flowchart illustrating a method 1700 that supports uplink control information mapping for uplink transmission switching in accordance with aspects of the present disclosure. The operations of the method 1700 may be implemented by a base station or its components as described herein. For example, the operations of the method 1700 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information. The operations of 1705 may be performed in accordance with examples as disclosed herein. In some examples, aspects of the operations of 1705 may be performed by an uplink transmission scheduling component 1125 as described with reference to FIG. 11.

At 1710, the method may include receiving, from the UE, the uplink control information in accordance with a modified cell mapping of the UE based on the uplink transmission switching. The operations of 1710 may be performed in accordance with examples as disclosed herein. In some examples, aspects of the operations of 1710 may be performed by a UCI receiver 1130 as described with reference to FIG. 11.

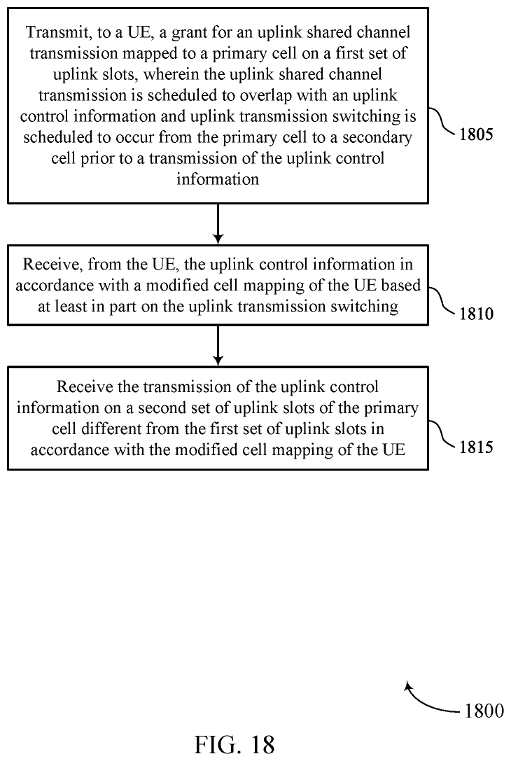

FIG. 18 shows a flowchart illustrating a method 1800 that supports uplink control information mapping for uplink transmission switching in accordance with aspects of the present disclosure. The operations of the method 1800 may be implemented by a base station or its components as described herein. For example, the operations of the method 1800 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1805, the method may include transmitting, to a UE, a grant for an uplink shared channel transmission mapped to a primary cell on a first set of uplink slots, where the uplink shared channel transmission is scheduled to overlap with an uplink control information and uplink transmission switching is scheduled to occur from the primary cell to a secondary cell prior to a transmission of the uplink control information. The operations of 1805 may be performed in accordance with examples as disclosed herein. In some examples, aspects of the operations of 1805 may be performed by an uplink transmission scheduling component 1125 as described with reference to FIG. 11.

At 1810, the method may include receiving, from the UE, the uplink control information in accordance with a modified cell mapping of the UE based on the uplink transmission switching. The operations of 1810 may be performed in accordance with examples as disclosed herein. In some examples, aspects of the operations of 1810 may be performed by a UCI receiver 1130 as described with reference to FIG. 11.

At 1815, the method may include receiving the transmission of the uplink control information on a second set of uplink slots of the primary cell different from the first set of uplink slots in accordance with the modified cell mapping of the UE. The operations of 1815 may be performed in accordance with examples as disclosed herein. In some examples, aspects of the operations of 1815 may be performed by a UCI receiver 1135 as described with reference to FIG. 11.

### Summary of Aspects

The following provides an overview of aspects of the present disclosure:

Aspect 1: A method for wireless communications at a UE, comprising: operating in accordance with an uplink carrier aggregation configuration on a primary cell and a secondary cell; receiving a grant for an uplink shared channel transmission mapped to the primary cell on a first set of uplink slots; generating uplink control information mapped to the secondary cell, wherein the uplink shared channel transmission is scheduled to overlap with the uplink control information and uplink transmission switching is scheduled to occur from the primary cell to the secondary cell prior to a transmission of the uplink control information; and modifying a cell mapping for the transmission of the uplink control information based at least in part on the uplink transmission switching.

Aspect 2: The method of aspect 1, wherein modifying the cell mapping for the transmission of the uplink control information further comprises: dropping the transmission of the uplink control information on the secondary cell based at least in part on the uplink transmission switching.

Aspect 3: The method of aspect 2, wherein the transmission of the uplink control information on the secondary cell is dropped for consecutive uplink slots of the primary cell.

Aspect 4: The method of aspect 1, wherein modifying the cell mapping for the transmission of the uplink control information further comprises: mapping the transmission of the uplink control information on the secondary cell to a second set of uplink slots of the primary cell different from the first set of uplink slots based at least in part on the uplink transmission switching.

Aspect 5: The method of aspect 4, wherein the second set of uplink slots comprise a subsequent set of consecutive slots that are available for transmission of the uplink control information.

Aspect 6: The method of aspect 1, wherein modifying the cell mapping for the transmission of the uplink control information further comprises: mapping the transmission of the uplink control information of the secondary cell from a first uplink slot of the secondary cell to a second uplink slot of the secondary cell based at least in part on the uplink transmission switching.

Aspect 7: The method of aspect 6, wherein the second uplink slot of the secondary cell is a subsequent slot that is available for transmission of the uplink control information.

Aspect 8: The method of any of aspects 1 through 7, wherein the uplink transmission switching further comprises: dropping the uplink shared channel transmission on the first set of uplink slots of the primary cell.

Aspect 9: The method of any of aspects 1 through 8, wherein the uplink carrier aggregation configuration is an inter-band carrier aggregation configuration supporting dual uplink transmission.

Aspect 10: The method of aspect 9, wherein the dual uplink transmission comprises at least one uplink transmission on one or more component carriers associated with the primary cell and the secondary cell.

Aspect 11: The method of any of aspects 1 through 10, wherein the uplink control information of the secondary cell is multiplexed with the uplink shared channel transmission of the primary cell.

Aspect 12: The method of any of aspects 1 through 11, wherein the primary cell is associated with a first carrier frequency and the secondary cell is associated with a second carrier frequency that is different from the first carrier frequency.

Aspect 13: The method of any of aspects 1 through 12, wherein the primary cell and the secondary cell are associated with a common cell group.

Aspect 14: A method for wireless communications at a base station, comprising: transmitting, to a UE, a grant for an uplink shared channel transmission mapped to a primary cell on a first set of uplink slots, wherein the uplink shared channel transmission is scheduled to overlap with an uplink control information and uplink transmission switching is scheduled to occur from the primary cell to a secondary cell prior to a transmission of the uplink control information; and receiving, from the UE, the uplink control information in accordance with a modified cell mapping of the UE based at least in part on the uplink transmission switching.

Aspect 15: The method of aspect 14, further comprising: receiving the transmission of the uplink control information on a second set of uplink slots of the primary cell different from the first set of uplink slots in accordance with the modified cell mapping of the UE.

Aspect 16: The method of aspect 15, wherein the second set of uplink slots comprise a subsequent set of consecutive slots that are available for transmission of the uplink control information.

Aspect 17: The method of any of aspects 14 through 16, wherein the uplink transmission switching further comprises: dropping the grant for the uplink shared channel transmission on the first set of uplink slots of the primary cell.

Aspect 18: The method of any of aspects 14 through 17, wherein the base station supports inter-band carrier aggregation for receiving uplink transmissions from the UE.

Aspect 19: The method of aspect 14, wherein the uplink control information is multiplexed with the uplink shared channel transmission of the primary cell.

Aspect 20: The method of any of aspects 14 through 19, wherein the primary cell is associated with a first carrier frequency and the secondary cell is associated with a second carrier frequency that is different from the first carrier frequency.

Aspect 21: The method of any of aspects 14 through 20, wherein the primary cell and the secondary cell are associated with a common cell group.

Aspect 22: An apparatus for wireless communications at a UE, comprising a processor; memory coupled with the processor; and instructions stored in the memory and executable by the processor to cause the apparatus to perform a method of any of aspects 1 through 13.

Aspect 23: An apparatus for wireless communications at a UE, comprising at least one means for performing a method of any of aspects 1 through 13.

Aspect 24: A non-transitory computer-readable medium storing code for wireless communications at a UE, the code comprising instructions executable by a processor to perform a method of any of aspects 1 through 13.

Aspect 25: An apparatus for wireless communications at a base station, comprising a processor; memory coupled with the processor; and instructions stored in the memory and executable by the processor to cause the apparatus to perform a method of any of aspects 14 through 21.

Aspect 26: An apparatus for wireless communications at a base station, comprising at least one means for performing a method of any of aspects 14 through 21.

Aspect 27: A non-transitory computer-readable medium storing code for wireless communications at a base station, the code comprising instructions executable by a processor to perform a method of any of aspects 14 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by at least one processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by at least one processor, the functions may be stored on or transmitted over as one or more instructions or code on a computer-readable medium. Other examples and implementations are within the scope of the disclosure and appended claims. For example, due to the nature of software, functions described herein may be implemented using software executed by at least one processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
operating in accordance with an uplink carrier aggregation configuration on a primary cell and a secondary cell;
receiving a grant for an uplink shared channel transmission mapped to the primary cell on a first set of uplink slots;
generating uplink control information mapped to the secondary cell, wherein the uplink shared channel transmission is scheduled to overlap with the uplink control information and uplink transmission switching is scheduled to occur from the primary cell to the secondary cell prior to a transmission of the uplink control information; and
modifying a cell mapping for the transmission of the uplink control information based at least in part on the uplink transmission switching.

2. The method of claim 1, wherein modifying the cell mapping for the transmission of the uplink control information further comprises:
dropping the transmission of the uplink control information on the secondary cell based at least in part on the uplink transmission switching.

3. The method of claim 2, wherein the transmission of the uplink control information on the secondary cell is dropped for consecutive uplink slots of the primary cell.

4. The method of claim 1, wherein modifying the cell mapping for the transmission of the uplink control information further comprises:
mapping the transmission of the uplink control information on the secondary cell to a second set of uplink slots of the primary cell different from the first set of uplink slots based at least in part on the uplink transmission switching.

5. The method of claim 4, wherein the second set of uplink slots comprise a subsequent set of consecutive slots that are available for transmission of the uplink control information.

6. The method of claim 1, wherein modifying the cell mapping for the transmission of the uplink control information further comprises:
mapping the transmission of the uplink control information of the secondary cell from a first uplink slot of the secondary cell to a second uplink slot of the secondary cell based at least in part on the uplink transmission switching.

7. The method of claim 6, wherein the second uplink slot of the secondary cell is a subsequent slot that is available for transmission of the uplink control information.

8. The method of claim 1, wherein the uplink transmission switching further comprises:
dropping the uplink shared channel transmission on the first set of uplink slots of the primary cell.

9. The method of claim 1, wherein the uplink carrier aggregation configuration is an inter-band carrier aggregation configuration supporting dual uplink transmission.

10. The method of claim 9, wherein the dual uplink transmission comprises at least one uplink transmission on one or more component carriers associated with the primary cell and the secondary cell.

11. The method of claim 1, wherein the uplink control information of the secondary cell is multiplexed with the uplink shared channel transmission of the primary cell.

12. The method of claim 1, wherein the primary cell is associated with a first carrier frequency and the secondary cell is associated with a second carrier frequency that is different from the first carrier frequency.

13. The method of claim 1, wherein the primary cell and the secondary cell are associated with a common cell group.

14. A method for wireless communications at a base station, comprising:
transmitting, to a user equipment (UE), a grant for an uplink shared channel transmission mapped to a primary cell on a first set of uplink slots, wherein the uplink shared channel transmission is scheduled to overlap with an uplink control information and uplink transmission switching is scheduled to occur from the primary cell to a secondary cell prior to a transmission of the uplink control information; and
receiving, from the UE, the uplink control information in accordance with a modified cell mapping of the UE based at least in part on the uplink transmission switching.

15. The method of claim 14, further comprising:
receiving the transmission of the uplink control information on a second set of uplink slots of the primary cell different from the first set of uplink slots in accordance with the modified cell mapping of the UE.

16. The method of claim 15, wherein the second set of uplink slots comprise a subsequent set of consecutive slots that are available for transmission of the uplink control information.

17. The method of claim 14, wherein the uplink transmission switching further comprises:
dropping the grant for the uplink shared channel transmission on the first set of uplink slots of the primary cell.

18. The method of claim 14, wherein the base station supports inter-band carrier aggregation for receiving uplink transmissions from the UE.

19. The method of claim 14, wherein the uplink control information is multiplexed with the uplink shared channel transmission of the primary cell.

20. The method of claim 14, wherein the primary cell is associated with a first carrier frequency and the secondary cell is associated with a second carrier frequency that is different from the first carrier frequency.

21. The method of claim 14, wherein the primary cell and the secondary cell are associated with a common cell group.

22. An apparatus for wireless communications at a user equipment (UE), comprising:
at least one processor;
memory coupled with the at least one processor; and
instructions stored in the memory and executable by the at least one processor to cause the apparatus to:
operate in accordance with an uplink carrier aggregation configuration on a primary cell and a secondary cell;
receive a grant for an uplink shared channel transmission mapped to the primary cell on a first set of uplink slots;
generate uplink control information mapped to the secondary cell, wherein the uplink shared channel transmission is scheduled to overlap with the uplink control information and uplink transmission switching is scheduled to occur from the primary cell to the secondary cell prior to a transmission of the uplink control information; and
modify a cell mapping for the transmission of the uplink control information based at least in part on the uplink transmission switching.

23. The apparatus of claim 22, wherein the instructions to modify the cell mapping for the transmission of the uplink control information are further executable by the at least one processor to cause the apparatus to:
drop the transmission of the uplink control information on the secondary cell based at least in part on the uplink transmission switching.

24. The apparatus of claim 23, wherein the transmission of the uplink control information on the secondary cell is dropped for consecutive uplink slots of the primary cell.

25. The apparatus of claim 22, wherein the instructions to modify the cell mapping for the transmission of the uplink control information are further executable by the at least one processor to cause the apparatus to:
map the transmission of the uplink control information on the secondary cell to a second set of uplink slots of the primary cell different from the first set of uplink slots based at least in part on the uplink transmission switching.

26. The apparatus of claim 25, wherein the second set of uplink slots comprise a subsequent set of consecutive slots that are available for transmission of the uplink control information.

27. The apparatus of claim 22, wherein the instructions to modify the cell mapping for the transmission of the uplink control information are further executable by the at least one processor to cause the apparatus to:
map the transmission of the uplink control information of the secondary cell from a first uplink slot of the secondary cell to a second uplink slot of the secondary cell based at least in part on the uplink transmission switching.

28. The apparatus of claim 27, wherein the second uplink slot of the secondary cell is a subsequent slot that is available for transmission of the uplink control information.

29. The apparatus of claim 22, wherein the instructions to uplink transmission switch are further executable by the at least one processor to cause the apparatus to:
drop the uplink shared channel transmission on the first set of uplink slots of the primary cell.

30. The apparatus of claim 22, wherein the uplink carrier aggregation configuration is an inter-band carrier aggregation configuration supporting dual uplink transmission.

31. The apparatus of claim 30, wherein the dual uplink transmission comprises at least one uplink transmission on one or more component carriers associated with the primary cell and the secondary cell.

32. The apparatus of claim 22, wherein the uplink control information of the secondary cell is multiplexed with the uplink shared channel transmission of the primary cell.

33. The apparatus of claim 22, wherein the primary cell is associated with a first carrier frequency and the secondary cell is associated with a second carrier frequency that is different from the first carrier frequency.

34. The apparatus of claim 22, wherein the primary cell and the secondary cell are associated with a common cell group.

35. An apparatus for wireless communications at a base station, comprising:
at least one processor;
memory coupled with the at least one processor; and
instructions stored in the memory and executable by the at least one processor to cause the apparatus to:
transmit, to a user equipment (UE), a grant for an uplink shared channel transmission mapped to a primary cell on a first set of uplink slots, wherein the uplink shared channel transmission is scheduled to overlap with an uplink control information and uplink transmission switching is scheduled to occur from the primary cell to a secondary cell prior to a transmission of the uplink control information; and
receive, from the UE, the uplink control information in accordance with a modified cell mapping of the UE based at least in part on the uplink transmission switching.

36. The apparatus of claim 35, wherein the instructions are further executable by the at least one processor to cause the apparatus to:
receive the transmission of the uplink control information on a second set of uplink slots of the primary cell different from the first set of uplink slots in accordance with the modified cell mapping of the UE.

37. The apparatus of claim 36, wherein the second set of uplink slots comprise a subsequent set of consecutive slots that are available for transmission of the uplink control information.

38. The apparatus of claim 35, wherein the instructions to uplink transmission switch are further executable by the at least one processor to cause the apparatus to:
drop the grant for the uplink shared channel transmission on the first set of uplink slots of the primary cell.

39. The apparatus of claim 35, wherein the base station supports inter-band carrier aggregation for receiving uplink transmissions from the UE.

40. The apparatus of claim 35, wherein the uplink control information is multiplexed with the uplink shared channel transmission of the primary cell.

41. The apparatus of claim 35, wherein the primary cell is associated with a first carrier frequency and the secondary cell is associated with a second carrier frequency that is different from the first carrier frequency.

42. The apparatus of claim 35, wherein the primary cell and the secondary cell are associated with a common cell group.

43. An apparatus for wireless communications at a user equipment (UE), comprising:
means for operating in accordance with an uplink carrier aggregation configuration on a primary cell and a secondary cell;
means for receiving a grant for an uplink shared channel transmission mapped to the primary cell on a first set of uplink slots;
means for generating uplink control information mapped to the secondary cell, wherein the uplink shared channel transmission is scheduled to overlap with the uplink control information and uplink transmission switching is scheduled to occur from the primary cell to the secondary cell prior to a transmission of the uplink control information; and
means for modifying a cell mapping for the transmission of the uplink control information based at least in part on the uplink transmission switching.

44. An apparatus for wireless communications at a base station, comprising:
means for transmitting, to a user equipment (UE), a grant for an uplink shared channel transmission mapped to a primary cell on a first set of uplink slots, wherein the uplink shared channel transmission is scheduled to overlap with an uplink control information and uplink transmission switching is scheduled to occur from the primary cell to a secondary cell prior to a transmission of the uplink control information; and
means for receiving, from the UE, the uplink control information in accordance with a modified cell mapping of the UE based at least in part on the uplink transmission switching.

45. A non-transitory computer-readable medium storing code for wireless communications at a user equipment (UE), the code comprising instructions executable by at least one processor to:
operate in accordance with an uplink carrier aggregation configuration on a primary cell and a secondary cell;
receive a grant for an uplink shared channel transmission mapped to the primary cell on a first set of uplink slots;
generate uplink control information mapped to the secondary cell, wherein the uplink shared channel transmission is scheduled to overlap with the uplink control information and uplink transmission switching is scheduled to occur from the primary cell to the secondary cell prior to a transmission of the uplink control information; and
modify a cell mapping for the transmission of the uplink control information based at least in part on the uplink transmission switching.

46. A non-transitory computer-readable medium storing code for wireless communications at a base station, the code comprising instructions executable by at least one processor to:
transmit, to a user equipment (UE), a grant for an uplink shared channel transmission mapped to a primary cell on a first set of uplink slots, wherein the uplink shared channel transmission is scheduled to overlap with an uplink control information and uplink transmission switching is scheduled to occur from the primary cell to a secondary cell prior to a transmission of the uplink control information; and
receive, from the UE, the uplink control information in accordance with a modified cell mapping of the UE based at least in part on the uplink transmission switching.
